(19) United States
(12) Patent Application Publication
(10) Pub. No.: US 2015/0058728 A1
(43) Pub. Date: Feb. 26, 2015

(54) AUDIO STREAM METADATA INTEGRATION AND INTERACTION

(71) Applicant: MS Technologies Corporation, Rockville, MD (US)

(72) Inventor: Edward Haggerty, Rehoboth Beach, DE (US)

(21) Appl. No.: 14/530,679

(22) Filed: Oct. 31, 2014

Related U.S. Application Data
(63) Continuation-in-part of application No. 14/160,964, filed on Jan. 22, 2014, now abandoned.
Application No. 14/160,964 is a continuation of application No. 13/948,060, filed on Jul. 22, 2013, now abandoned.

(51) Int. Cl. G06F 3/0484; G06F 3/0482; H04W 4/02

(52) U.S. Cl. CPC G06F 3/04842; H04W 4/02; G06F 3/0482
USPC 715/716

(57) ABSTRACT

A media interaction system for audio stream metadata integration and interaction with a communications device, an interface for receiving live or delayed audio from a plurality of user devices, and a storage subsystem coupled to the communications device and configured to buffer at least a configurable amount of live audio received from a user device via the interface. Upon receipt of a request from a user, the buffer is screened for metadata comprising contact information and, where contact information is located, an interaction between the user and another party is initiated using the communications device and the contact information.

### CROSS-REFERENCE TO RELATED APPLICATIONS

This application is a continuation-in-part of U.S. patent application Ser. No. 14/160,964, titled “AUDIO STREAM METADATA INTEGRATION AND INTERACTION” and filed on Jan. 22, 2014, which is a continuation of United Stated patent application Ser. No. 13/948,060, titled “AUDIO STREAM METADATA INTEGRATION AND INTERACTION” and filed on Jul. 22, 2013, the entire specification of which is incorporated herein by reference in its entirety.

### BACKGROUND OF THE INVENTION

1. Field of the Invention

The invention relates to the field of digital media, and more particularly to the field of associating relevant information with media playback for interaction by a media user.

2. Discussion of the State of the Art

In the art there exists a broad desire to link media use (such as listening to music or watching a video) with additional information that may be relevant to the media being viewed but that in itself may not necessarily be audio or visual in nature. An immediately apparent example of this would be a late-night television advertisement, trying to sell a product to viewers who were in all likelihood watching something completely unrelated to the advertisement before it came on. In these ads, contact information may be given such a phone number, e-mail address, or website. This is desirable to encourage viewers to pursue the advertisement and learn more about the material, or to contact the vendor for purchase of a product or service.

Another presently-available example would be a radio advertisement, such as for a radio contest. The audio might inform listeners that they are giving away tickets to a concert (often relevant to the music that was being played prior to the advertisement broadcast), and may provide a phone number to call or send a text message to.

As the art has evolved, such uses have been surpassed by other technological media such as streaming audio via an internet-enabled service such as PANDORA™ or other internet radio service providers. Such services are often used on internet-enabled devices that may perform a variety of functions, such as a personal computer or a smartphone. While advertisements may still be present (some services offer a no-advertisement paid subscription, but this is often not the default behavior), they are still bound to merely playing audio or video representations of information such as a radio ad saying a phone number repeatedly so a listener may remember it, or a video playing a video-based advertisement for a product. In such cases, there still exists a hurdle when a listener or viewer may desire to make contact. A phone number would have to be written down or memorized, or the name of a product in a video might be forgotten. Such information is often presented in less-than-ideal conditions, such as a radio advertisement while driving or a video ad being played in a theater. With modern electronic devices, it should be easy to utilize other device functions to interact, as these devices are already capable of effortless note-taking or recording functionalities, yet such utilization is overlooked in favor of following an established pattern of behavior from previous decades when such functionality was only fantasy.

What is needed, is a means to integrate such relevant information with the media being provided, to take advantage of technological advancements in media devices as well as provide an additional layer of functionality for existing “less advanced” devices to allow users to interact more directly with this information, such as to enable any media consumer to interact more conveniently when desired, without placing any new requirements on their media consumption habits.

### SUMMARY OF THE INVENTION

Accordingly, the inventor has conceived and reduced to practice, in a preferred embodiment of the invention, systems and method for associating information with media content and providing means for user interaction with such information during media consumption.

According to a preferred embodiment of the invention, a media interaction system for audio stream metadata integration and interaction comprising a communications device comprising program code stored in a memory and adapted to facilitate user communication with similar devices via a data communication network; a software interface comprising program code stored in a memory and adapted to receive live or delayed audio from a plurality of user devices; and a data storage subsystem coupled to the communications device and adapted to buffer at least a configurable amount of live audio received from a user device via the interface; wherein upon receipt of a spoken request from a user, the buffer is screened for metadata comprising contact information and, where contact information is located, an interaction between the user and another party is initiated using the communications device and the contact information, is disclosed.

According to another preferred embodiment of the invention, a method for audio stream metadata integration and interaction comprising the steps of: buffering, using a data storage subsystem, at least a configurable amount of live audio received from a user device via an interface for receiving live or delayed audio from a plurality of user devices; screening the buffer for metadata comprising contact information on receipt of a spoken request from a user; and initiating an interaction between the user and another party using a communications device and based at least in part on contact information found in the buffer, is disclosed.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is a block diagram of an exemplary system for media information association and interaction utilizing a software application operating on a media device, according to a preferred embodiment of the invention.

FIG. 5 is a block diagram of an alternate system for providing media information association and interaction utilizing a server-based architecture, according to a preferred embodiment of the invention.

FIG. 6 is a block diagram of an alternate system for providing media information association and interaction utilizing direct device interaction, according to a preferred embodiment of the invention.

FIG. 7 is a method diagram illustrating an exemplary method for interaction with associated media information, according to an embodiment of the invention.

### DETAILED DESCRIPTION

The inventor has conceived, and reduced to practice, systems and method for associating information with media content and providing means for interaction with such information to a media consumer.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DEFINITIONS

“Media”, as used herein, refers to any sort of information presented to a user for purpose of information consumption, whether it be a video (such as watching a movie or an online video clip), audio (such as listening to music on a radio or software application for audio streaming), or any other nature for media presentation.

A “user”, as used herein, refers to any individual or entity that may desire to access, view, or interact with media for any reason, such as a person watching a movie or listening to music, or any other such means of information consumption. In the text hereafter, may also be referred to as a “consumer” or “media consumer”, and such terms are used interchangeably.

“Metadata”, as used herein, may refer to any form of information or content that may be relevant to media content. Such information might be of varied nature and need not adhere to any particular format or standard, a key concept of the invention being that any arbitrary data may be associated with media for user interaction. Such metadata may therefore be text, audio, or video-based in nature, as appropriate for the information being presented. For example, in some embodiments, metadata could be as simple as a phone number provided near the end of an advertisement (e.g., “For more information, dial 1-800-555-1212”).

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

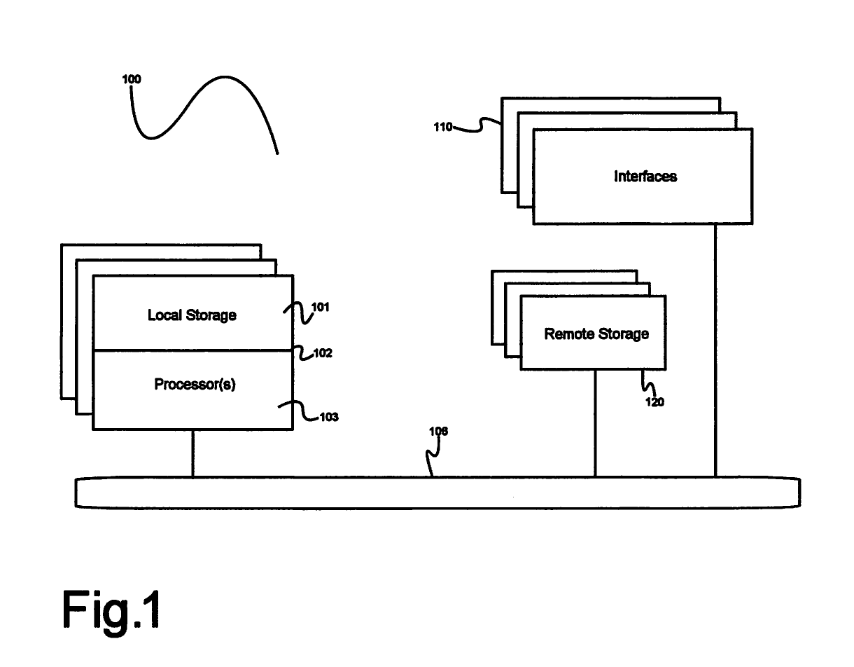

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

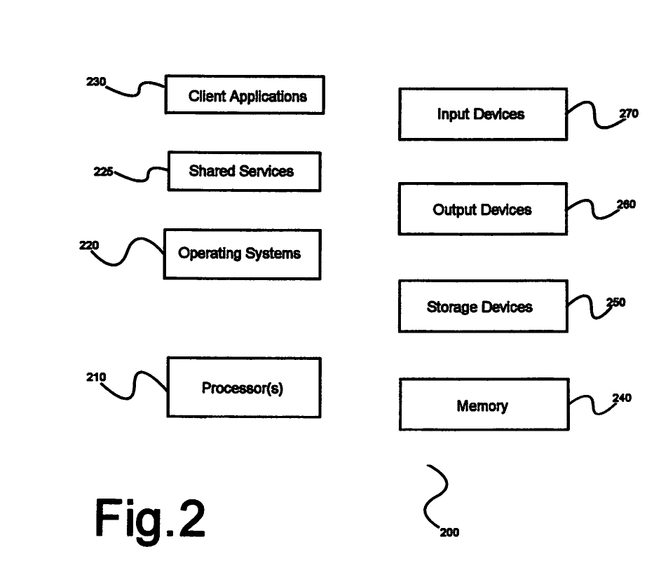

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

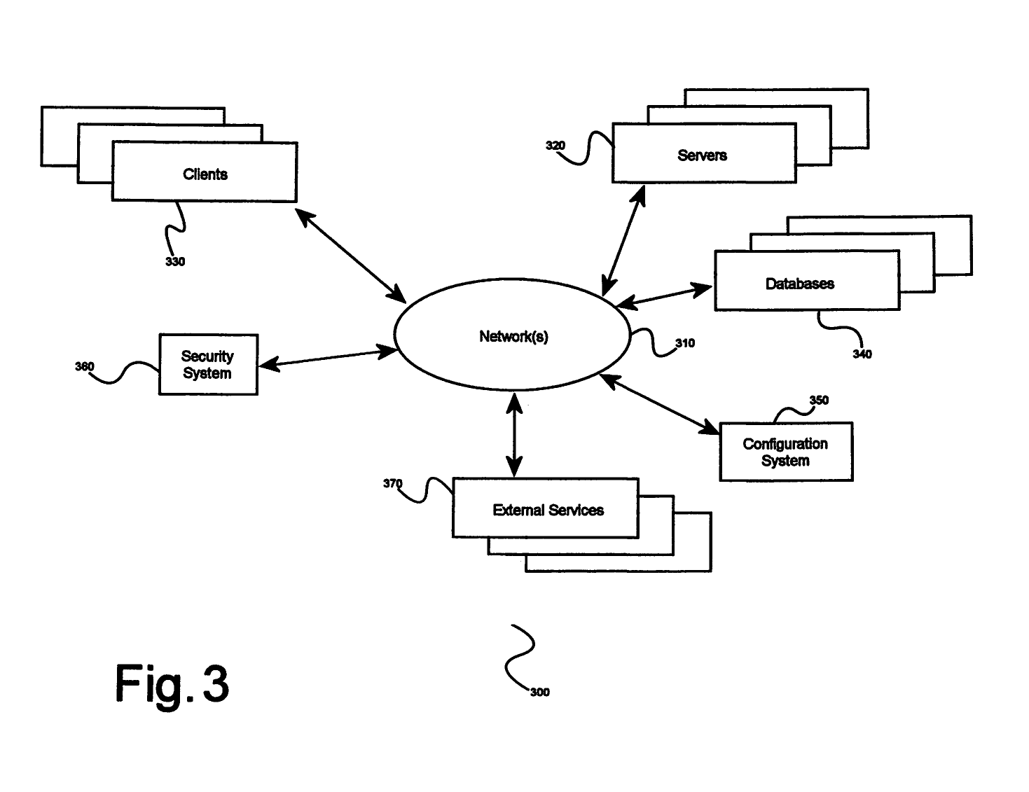

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

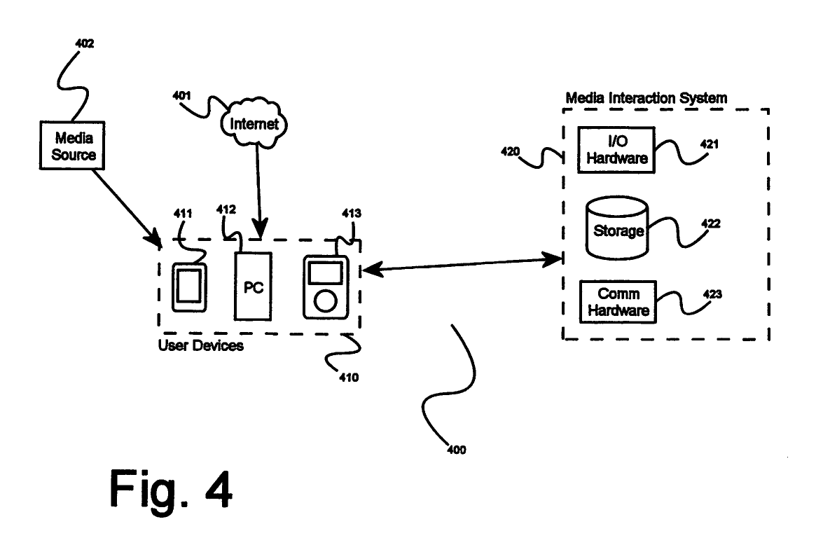

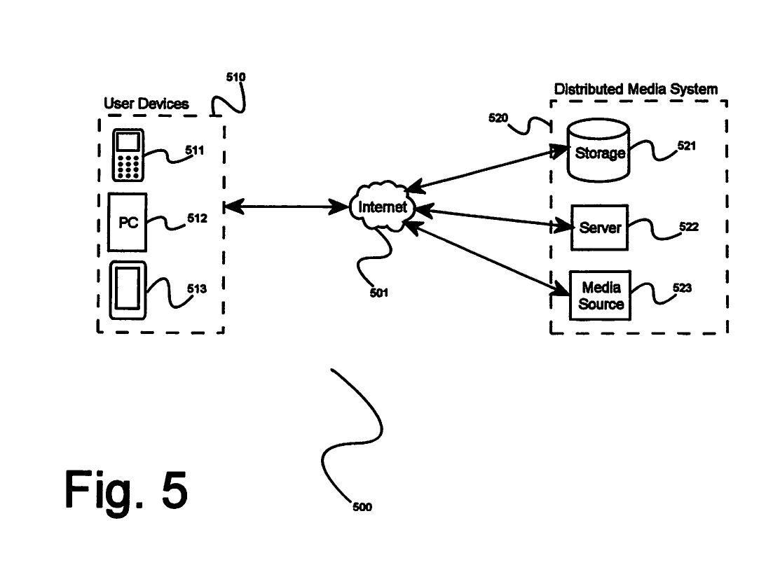

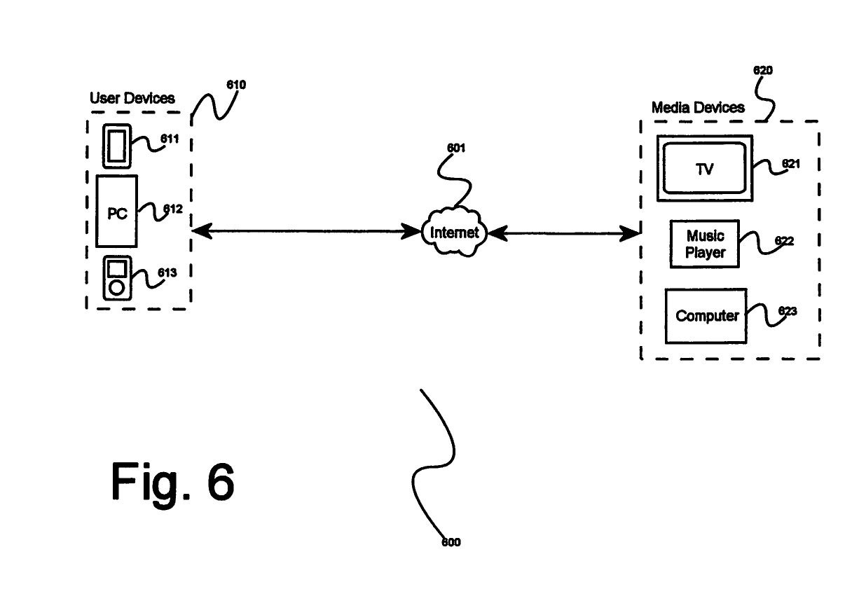

FIG. 4 is a block diagram of an exemplary system 400 for associating metadata with media content and providing for user interaction, according to a preferred embodiment of the invention. As illustrated, according to the embodiment elements of system 400 may operate jointly or in part within an electronic media device 410, such as a smartphone 411, personal computer 412 such as a laptop or desktop computer system, or music player 413 such as any of a variety of mp3 (or other audio file format or container) players as are common in the art. It should be appreciated that while the arrangement illustrated demonstrates a system with all components residing similarly within a device for unified function (such as a software “app” that may be installed on a device and provide full functionality for convenience of a user), alternate arrangements may comprise elements stored or operating on remote devices such as computing servers or cloud-based software services, according to the invention. Alternate arrangements are described in detail below comprising server-based arrangements (referring to FIG. 5), as well as direct peer-to-peer (P2P) connection between media devices (referring to FIG. 6).

As illustrated, a media device may vary in specific nature, and additional or alternate devices not illustrated may be utilized according to the invention. By way of example, several devices are illustrated that may operate features or functions of system 400 according to the invention. Such devices should ideally be capable of operating a variety of hardware and software features relevant to system 400 such as user input/output hardware device 421 such as microphone, speaker, or other user input/output devices, storage system 422 that may be a computing device comprising program code stored in a memory and adapted to store and provide data to other components of a system 400, or communication system 423 such as a cellular, internet, radio, or other hardware-based communication system for facilitating interaction between devices or between a device and a communications network such as the Internet 401. It should be appreciated that while devices as illustrated should ideally be capable of operating illustrated functions or elements of system 400 on their own, additional hardware or software means may be utilized in conjunction with such exemplary devices as illustrated to provide additional or alternate functionality (such as a modular hardware upgrade that may be added to an existing personal computer 412 to provide expanded functionality, or the storing of new or additional program code in a memory), according to the invention.

As illustrated, devices may be in communication with the Internet 401 or other data communications network such as a cellular communications network, radio broadcast network, television broadcast network, or alternately may be connected to and in communication with other devices without the use of a broader network capability, such as a direct cable connection to a device 402 that may provide media content such as a computing server, according to the invention. In this manner it can be appreciated that devices operating system 400 may be in communication with any appropriate source of media content, and that in this manner system 400 may be seen to be scalable to various arrangements of devices and adaptable to various device or communication technologies.

According to the embodiment, a user may interact with a device 410 such as for media consumption purposes (such as listening to music, watching video, or other such uses common in electronic devices present in the art). Device 410 may provide media content (songs, videos, etc.) from any appropriate source such as streaming media from a source via the Internet 401 or other communications network (such as when listening to a radio broadcast or Internet-based music service such as PANDORA™), or may access or request media content from a device known to operate a media repository such as a media server 402 or similar device that may store or operate media content or media services. For example, in an exemplary arrangement a user may be listening to streaming audio via an in-car music player. The streaming audio may be retrieved from a user's mobile phone or media device, or may be received via terrestrial or satellite broadcasts, as are common in the art.

According to the embodiment, when media is presented to device 410 a software component operating within or upon device 410 may associate known metadata with the media content, such as identifying a song being played and associating song information (such as a song name, artist name, year a song was recorded, or any of a variety of other information relevant to the media content) with such media, and ideally may do so in a manner that does not alter the media itself or interrupt user experience (i.e., enhancing media content with metadata stored on a device, without delaying or altering the media content being presented to a user). In this manner, functionality as provided by the invention may be provided to any and all users regardless of their particular desire to utilize the invention, without any negative consequences for doing so. Enabling such functionality only provides users the option of interacting with enhanced media or metadata, no change in user behavior or experience may be required and effectively the invention provides the option of enhanced functionality with no downside from the perspective of a user. For example, continuing the exemplary arrangement described previously, a user's in-car media player may identify a song being received and associate known metadata such as ID3 or other tag-based information (as is common in the art) with the song, without causing any delay or stuttering in the audio playback to the user. This information may then be available for further use according to the invention, such as described below, and may optionally be made available to the user such as via a media info display (for example, displaying the artist or track name of the current media, as is common in the art) or audio announcement (such as speaking the song name after playback has finished, for example).

According to the embodiment, when a user is being presented with media content they may at any point desire to interact with metadata associated with such content—such as, for example, identifying a song's information to search online or in local vendors such as to purchase the album or to find similar works by the song's artist, or contacting a video uploader or provider of a product or service shown in a video during viewing, such as to learn more about a product being shown or to contact a video creator for further information. According to the embodiment, such metadata may be associated with the media content as described above, such that a user may easily access relevant or desirable information conveniently or without interrupting media consumption. As illustrated, a user may interact with an input device 421 to interact with the media content or its associated metadata—for example, a user operating a smartphone 411 may use a built-in microphone to verbally (spoken) request information on a song being played, or a user on a personal computer 412 might use a mouse or other common input device to view information associated with the media (such as with an interactive interface element such as a button that a user may click to “view more info” on any particular video). In this manner, for example, a smartphone user might listen to a song from any appropriate source, and verbally request (i.e., make a spoken request for) information via any appropriate voice input software as is common in the art particularly for such devices, such as a virtual personal assistant such as SIRI™ or speech-to-text software application. For example, while listening to a song a user might make a verbal (spoken) request such as “tell me the name of this song”, enabling them to retrieve media information hands-free (such as may be desirable while listening to media while driving or during any other activity that may preclude a user from touching, viewing, or otherwise physically interacting with their media device during media playback). It will be appreciated by one having skill in the art, that such functionality may easily be extended to provide additional functionality such as searching nearby stores or online vendors for a DVD of a movie being viewed, or composing an e-mail or other message to a contact address associated with media content. In this manner, the functionality of system 400 is scalable in nature in that the potential interactions available to users are not limited except by the type or quantity of information being provided for association with media content. Such data may be provided by a media content source, such as a video uploader adding contact information to a video for viewing or interaction online via such services as YOUTUBE™, or an audio broadcaster including song information with their broadcasts (such as may be useful for radio stations or internet-based audio streaming services like Pandora™). It should be appreciated that the means provided for interaction with such data may vary, such clickable or interactive interface elements (such as a “song info” button on an internet radio app for a mobile device), verbal (such as an above example, verbally asking for song information), or any other means of interaction as may be appropriate according to a particular device or media content, according to the invention.

According to the embodiment, in some arrangements functionality provided by system 400 may be integrated with existing interaction software using (for example) a speech-to-text software application programming interface (API) that may provide for easy integration with existing products, again allowing a simple and convenient solution for users (for example, a user may install a single app on their device and various software elements may interact with each other without user interaction or optionally without even notifying a user, such that a user's experience is that a software application or service provided by the invention “just works”, even with other services or applications that may not previously have had such functionality, making the addition of such functionality as convenient and unobtrusive to a user's experience as possible and encouraging use. An example of such integrated functionality might be the addition of (for example) clickable or otherwise interactive interface elements such as buttons or text-based hyperlinks in a web browser, adding functionality for interacting with information via an existing browser such that a user may continue to utilize products or services (in this example, a web browser) with which they may already be familiar, but with the option of expanded functionality provided by integration with system 400. An additional use of such integration may be integration with various communication means on a device as appropriate, such as integration with a phone or text messaging app on a mobile device such as a smartphone 411. For example, while listening to a radio broadcast on a mobile device, a user might (using verbal interaction as described above) request to contact the radio broadcaster or call a specific number that was mentioned (such as for a radio contest where callers may be directed to a specific number), such as by saying “call that number”, or “call the last number mentioned”, or “call 555-1234” if a user remembers the specific number to be dialed. In this manner, information associated with media may make a contact number known, and integrated apps such as a phone (as described in the example) may access this information when requested.

According to the embodiment, a storage repository for media information may be utilized, such as a database 422, that may store any known media information such as to make it available when verbally requested by a user or by an integrated application, and that may store any needed information for use in determining what information to associate with media content (i.e., which information is relevant to this particular audio stream). In this manner, a plurality of media information may be stored and presented for association as described above, without needing to previously associate such information with individual media content manually. For example, rather than attach contact information to specific radio broadcasts manually, a radio broadcaster may schedule an advertisement (for example) to be played at a known time on a known radio station. Any means of receiving such a broadcast (such as a mobile app or a radio receiver such as is common in automobiles for listening while driving) may have access to basic station or time information, and such information may then be used for association with media information. For example, while listening to a radio broadcast on a smartphone, a station and exact time may be already known and may be used to retrieve a specific piece of media information from a repository upon spoken request. In this manner, media content need not be altered, adding inconvenience for media providers, and instead a repository may be created from which information may be “fetched” as needed.

An additional use of such information storage functionality may be the retrieval of information after it has been presented, such as a user hearing a phone number in an advertisement and waiting until the end of the advertisement to request a contact. In such a use, a “buffer” of information may be maintained, such that when requested a specified length of prior media may be used to determine what information to present (such as determining the correct phone number based on the last advertisement that was broadcast), such that a user may request interaction even after a particular media stream may have ended, such as a user requesting contact with a number heard during a previous advertisement even after the ad may have ended and other media has begun. It will be apparent that according to such use, additional functionality for a user to further refine or specify the information being requested may be utilized as appropriate, such as a user specifically requesting “the number from the previous commercial”, or “the first number played in the last thirty seconds”. It should be appreciated that such requests or interactions are exemplary, and any of a wide variety of specific requests may be made according to the invention, and that the functionality of such functionality is not limited by system 400 in any way and may only be limited by software or hardware features of a device being utilized according to the embodiment (for example, some devices may have the capacity to process more specific voice commands, while some device may be better suited to text-based input, while both devices continue to operate according to the invention without any alterations required of system 400). It should be appreciated that such an arrangement enables the use of third-party vendors that may maintain repositories of information or may provide hardware or software products or services for creation or operation of such repositories, and such an alternate embodiment is described in greater detail below, referring to FIG. 5. It should be further appreciated that variations of media information storage may be possible according to the invention, such as utilizing a temporary storage of recently-played media to allow for interaction with previously-presented information (such as in a prior example, “call the number form the last commercial”). Additionally, multiple storage repositories may be utilized such as to separate storage for multiple media types or sources, as may be appropriate to provide similar functionality according to the embodiment using media from a variety of providers that may desire to keep their own information distinct from one another. According to such an arrangement, it may be desirable to have “update” or “expansion” software that may be presented to a user to add to their device to expand functionality of a system 400—for example, a user may install a smartphone app providing basic functionality according to the embodiment, but wish to also install an add-on package that adds media information for a specific media source such as a favorite internet radio station, allowing users to tailor their own interactions or options according to their preference, while still optionally providing a baseline functionality that may be available to all users. It should be appreciated that such an arrangement featuring multiple storage repositories may be desirable to preserve and enforce boundaries across information sources, providing a measure of security to system 400 and enabling multiple vendors to provide repositories of metadata without fear that their information may be vulnerable to competitors or other parties. An apparent exemplary scenario might comprise a user utilizing metadata repositories for products from a plurality of competing vendors to aid in a purchasing decision, but each vendor may desire to keep their information secure from others in their market.

According to the embodiment, a further use of system 400 may be provided in addition to the previously described uses of media information (such as song details like an artist name or album title) or contact interaction (such as contacting a party based on an advertisement), but also optionally the inclusion of metadata that may enhance a media consumption experience. For example, a provider of media content may associate additional metadata with a particular piece of media, which may provide information regarding the content of the media. An example of this might be inclusion of biographical data on a speaker when viewing a video of a conference, or interactive links to further sources of information—for example, while viewing a news broadcast a user might be able to request that a browser open a link to additional information regarding an issue while still leaving the broadcast playing. In this manner, it can be appreciated that the functionality offered by system 400 and alternate arrangements described below (referring to FIG. 5 and FIG. 6) need not be limited to a marketing or advertising capacity and may be utilized for enhancing a user's experience in other ways. It should be further appreciated that such uses as described are exemplary and that a wide variety of potential arrangements and implementations may be possible according to the invention, and that such exemplary uses are provided only for the sake of brevity and are by no means limiting of the functionality or appropriateness of the invention for any particular use. It should be appreciated by one having skill in the art that the basic features and functions described provide for a broad functionality that may be adapted to many uses for many purposes, and that any particular arrangement may be tailored to a specific use or need according to the invention.

A further utility provided by such a device-based arrangement as illustrated, is that functionality of system 400 may be achieved with no outside connectivity. That is, a device 410 may operate all necessary components, as illustrated and no external components may be required for functionality to be provided to a user. An exemplary use of such functionality may be a user who hears an audio broadcast from a device not their own (such as hearing a song played over a speaker system, such as is common in many stores, restaurants and other venues in the art). A user may then interact with their device such as described above, and media information (if available) may then be presented. For example, in such a use case a media storage repository 422 may store information used to identify media for association of metadata, such as specific audio or video cues that may be identified in media content for identification. An example of similar functionality in the art is a song identification service such as SOUNDHOUND™, which may take a length of audio recording and utilize that audio to search for media information. According to the embodiment, rather than search the Internet 401 or perform similar cloud-based searching for media information, a device may use recorded cues to search a previously-stored repository as described above. In this manner, one might think of the functionality as a sort of “offline mode” of similar media services, allowing users to load a repository of metadata and use it for enhancing their media consumption experience without any external connection or interaction, solely based on the functionality present on their device.

It should be appreciated by one having ordinary skill in the art that such use for identifying song information as described above is exemplary and a variety of uses may be possible according to the invention, and that as technology and methods in the art continue to develop new uses and functions may become available according to the invention. An exemplary use that may become more practical as technology continue to improve, may be video identification similar to the audio identification described above. A user might point a device's camera at an object, location, or individual, and an image or video clip may be recorded and used similarly for identification of additional information. Facial recognition software may enhance such functionality, such as enabling a user to take a picture of a speaker at a conference and then request additional information such as their credentials or other fields of expertise. In this manner, it can be appreciated that the invention provides not only a means for enhancing media consumption for users, but also in effect an “augmented reality” functionality that may be used to enhance many aspects of a user's daily activity. Metadata integration and interaction according to the invention need not be limited to only media consumption and may be relevant and useful in a wide variety of areas, and all uses and functions described herein are provided only by way of example, to illustrate basic functions and principles of the invention that may be applied to many areas in a wide variety of ways.

FIG. 5 is a block diagram of an exemplary system 500 providing an alternate means of associating metadata with media content and providing for user interaction utilizing a distributed approach to system architecture, according to a preferred embodiment of the invention. According to the embodiment, system 500 may perform similar basic functionality as described above (referring to system 400 of FIG. 4), but may operate in a distributed capacity utilizing remote hardware or software elements such as cloud-based services to provide for specific functions of system 500, according to the invention. In this manner, the functionality provided by the invention may be utilized by users without requiring a user's particular device to operate features of a system itself. Such use may be appropriate, for example, when a user is using a device incapable of certain function as described previously (again, referring to FIG. 4), such as an ordinary cellphone 511. It should be appreciated that such function may not be provided out of necessity, and that other devices may interact with system 500 with no impact on function or features, such as a personal computer 512 or smartphone 513, and that such use may be desirable for any of a number of reasons—such as, for example, a user on a corporate computer may not be authorized to install software for personal use, and may wish to utilize the features of system 500 without making any alterations to their computer. Another example might be a user with a smartphone that may have limited storage capacity, encouraging the user to avoid installing software or potentially large information repositories (as described above, referring to FIG. 4).

According to the embodiment, a device 510 may connect to and communicate with other elements of system 500 via the Internet 501 or other communication means such as a cellular communications network, radio communications network, or direct connection such as via cables or other physical communication means, and furthermore that additional or alternate communication means may be utilized interchangeably or in conjunction to provide for communication connection between components regardless of the particular network capabilities of any one device. In this manner it can be appreciated that the functionality provided need not be limited by any particular device's own capabilities or connectivity, and a variety of additional or alternate means may be utilized according to the invention. According to the embodiment, external software or hardware components may be utilized as appropriate to provide functionality to a device, and it should be appreciated that utilization of such external sources may vary according to a device's capabilities—for example, a device may be capable of operating some features or functions of system 500 but lack the storage necessary to maintain an internal metadata repository, and therefor may utilize an external repository 521 as illustrated, to accommodate for the limitations of the device itself without limiting functionality provided to a user. Such external interaction may be configurable such as a stored configuration file that may be utilized by system 500 to determine functionality, or may be interactively configurable such as a user selecting which features to connect to a network for (as is common in many applications for smartphones or other mobile devices, that may give a user the option of using an internet connection for certain features), or may be automated such as system 500 detecting a device's capabilities and automatically connecting to and communicating with external sources as needed to enable full functionality without impacting user experience or requiring any additional configuration or technical interaction from a user, thereby providing a convenient and user-friendly solution for a variety of device types.

As illustrated, external components may include a storage repository 521 that may store or provide metadata or other information for system operation, server 522 that may operate software processing for system operation, or media source 523 that may provide media content for user consumption and interaction according to the invention. It should be appreciated that due to the nature of cloud-based services and according to the function of system 500 according to the invention, additional or alternate external components may be utilized such as the inclusion of multiple data repositories, a network of connected servers for enhanced processing, or other such arrangements.

As illustrated and as described previously (referring to FIG. 4), a storage repository 521 may be utilized such as to store metadata for association with media content, as well as for such additional purposes as (for example) storing media identification cues (such as for identifying a particular media stream as described above, referring again to FIG. 4) or any other such information that may be relevant to media content or to a user desiring interaction according to the invention. According to the embodiment, such storage may be operated by a third-party vendor as is common in the art, such as Amazon S3™ or any similar internet-based storage service, such that storage may be accessible regardless of physical location or device being used, interaction requiring only that a communication connection is available. Such cloud-based storage solutions may be desirable for a variety of reasons, such as secure offsite storage of sensitive information, or storage of large quantities of information.

As further illustrated, a plurality of servers 522 may be utilized such as for performing software-related processing, such as (for example) providing media identification to determine metadata for association or provision to a user, or for other such processing tasks that may be desirable to be performed on a remote computing system. For example, it may be desirable to perform certain operations, such as bulk metadata association with a large quantity of media content, externally from a user's device to hardware constraints. It will be appreciated by one having ordinary skill in the art that no mobile device (such as a smartphone or tablet computing device) can compare to a server computing system in terms of processing capacity, so use of such server-based systems may be desirable such as to expedite processing or to perform tasks that may be physical impossible for a user's device to perform unaided.

As further illustrated, a plurality of media sources 523 may be utilized according to the invention, such as to provide media content to users or to other components of system 500. According to the embodiment, such sources may vary in nature or operation such as traditional radio broadcasting stations, television news studios, internet audio or video media streaming sources such as YOUTUBE™ or PANDORA™, or any other source of media for user consumption. According to the invention, such media sources may operate uninterrupted and still be a component of system 500 for use, as media metadata may be stored on a repository 521 and associated with media as needed by servers 522, thus removing any requirement for a media provider to alter their operation or media being provided, while still providing full functionality according to the invention.

It will be appreciated by one having ordinary skill in the art, that as illustrated a distributed system 500 may operate according to the various functionalities described previously (referring to FIG. 4), and that a distributed approach as illustrated does not inhibit any particular function or use case. Such an arrangement is beneficial for users with devices that may lack the technological capability to operate such functionality themselves (such as described above, referring to FIG. 4), or for users or providers that may desire a cloud-based approach for any reason, such as a user with a device that may have limited storage but unlimited network connectivity (such as a smartphone with appropriate service plan), or a provider of media or metadata that may wish to operate storage or processing functionality offsite such as for security or reliability of operation.

It will be further appreciated that the use of such a distributed arrangement as illustrated may allow for a service-based approach to providing functionality according to the invention—i.e., a company may seek to operate a metadata service by providing repositories of metadata for media or providing their own processing software or hardware for use in metadata association or interaction. For example, an advertising agency may offer an “upsell” or additional feature that may be purchased along with an advertising spot (“increase sales by enabling live interaction!”), offering to provide enhanced functionality via association of interactive metadata—such as offering an upgrade feature to a vendor purchasing an ad spot, offering the inclusion of clickable or otherwise interactive contact features (such as “call to:” links that may initiate contact with a company representative) with the media content being presented in the advertisement. It should be appreciated that such a use is exemplary, and many alternate or additional uses of such functionality may be apparent and may be utilized according to the invention.

An additional feature expanding on the previous example of an advertising service provider offering interactive metadata as an upsell feature, is that no media recording or processing may be needed as metadata may be directly interactive from within the media content it is associated with. Essentially, a service provider may embed or attach metadata to media content as a component feature of the service they provide, which may increase speed or relevancy of operation. This may increase convenience for some users as compared to an arrangement that involves recording a “snapshot” or “snippet” of media content in order to determine which metadata should be associated with it. Additionally, such a service may be integrated with other software operations such as speech-to-text or virtual assistant software as described above (referring to FIG. 4), enabling smooth integration of a cloud-based service with a variety of devices and interaction means. This may provide a more accessible service for users, eliminating the need for additional software to be configured or installed in order to interact with any particular service provider, instead utilizing such software that users may already be familiar with (or at least already have available to them). It should be appreciated that such a configuration is exemplary, and alternate or additional configurations may be utilized according to the invention. Accordingly, a distributed system 500 may utilize stored or dynamic media recording as described previously (referring to FIG. 4, describing the use of a short segment of media for us in determining media information for metadata retrieval or presentation), such as to enable interaction with metadata after media has finished playback or retrieval of metadata from known previous or alternate media (such as enabling a user to view one news channel while interacting with metadata from another channel such as viewing current headlines or performing an internet search on a specific story. In this manner, functionality of a system may be used not only to enhance consumption of media content, but also to enable consumption of content from multiple sources simultaneously in a novel manner that may be useful and accessible to a user. It will be appreciated that convenience may be a large factor in a user's media consumption activities, and by providing a system 500 that may handle the bulk of operation (such as processing media, retrieving relevant metadata, and presenting such metadata on request), a user may enjoy new and desirable means of consumption with minimal inconvenience or learning curve, and may always have the option to choose not to utilize such functionality and instead operate traditionally, with no metadata being requested or provided, effecting a familiar experience while additional features remain available should they be desired at a later time.

FIG. 6 is a block illustration of an exemplary system 600 for an alternate means of providing metadata association and interaction, according to a preferred embodiment of the invention. According to the embodiment, system 600 may comprise a plurality of media devices 610 such as a television 611, music player 612 (such as a CD, DVD, or mp3 player, or any other appropriate music playback device), or other electronic devices not necessarily dedicated to a media function, such as a personal computer 613. System 600 may further comprise a plurality of user devices 620 such as a smartphone 621, personal computing device 622 (such as a desktop, laptop, or tablet computing device), or other media receiver 623 (such as an automobile radio or similar device designed for such purposes as providing media playback), that may interact directly with media source devices 610 via any of a variety of communication means available in the art such as via the Internet 601, any of a variety of cellular communication frequencies or protocols, radio communication, Bluetooth™, or wireless media streaming protocols as are available and are becoming available in the art. It should be appreciated that either device may initiate communication between devices, and that a particular means of communication (such as selecting a particular cellular frequency to communicate on) may be determined by one or both devices, ideally requiring no user interaction. It should be further appreciated that such communication configuration may optionally be user-controllable, as may be desirable for technically oriented users or users who wish to maintain control of their device operations. For example, a user operating a smartphone 621 may optionally select to use Wi-Fi only for media interaction, denying any cellular connections as may be desirable according to a user's particular service plan on their device, a feature that is common on such devices in the art. Furthermore, it should be appreciated that while the Internet 601 is illustrated, a network-based connection is optional and various ad-hoc connection means common in the art may be utilized for direct communication between multiple devices according to the invention.

According to the embodiment, communication between a media source 610 and a user's device 620 may be initiated from either device. For example, a media source may send media metadata on a broadcast frequency for reception by any appropriately-capable device within range (thus initiating communication with any user devices nearby), or a user may request to connect from their device, such as starting an appropriate mobile app for media interaction. Regardless of the initiator of the interaction, once communication is begun the two devices may communicate with one another directly in a P2P manner, requiring no external or networked devices to facilitate interaction. In this manner, a user may use their device (such as, for example, a smartphone 621) to request or interact with metadata associated with media being broadcast from another device, regardless of their connectivity and without the need for storing large amounts of media or metadata information on their device or subscribing to a third-party service (as described previously, referring to FIG. 4 and FIG. 5, respectively).

According to the embodiment, any metadata for interaction must be available to one or both devices without external access or communication, in order for a P2P interaction to function. Accordingly, metadata may be embedded or attached to media content, such that the metadata is immediately available to any device capable of receiving or utilizing such content. Such means of embedding data are common in the art, such as embedding song information within an MP3-formatted audio file using ID3 tags or similar protocols common in the art. According to the invention, such means may be used to embed additional information as may be desirable, such as contact information, web addresses for further information, or even embedding additional information such as trivia or additional information expanding on the media itself. In this manner, any capable device may have metadata accessible to it with no extra configuration, and with no external hardware or software required. Functionality according to the invention is provided by the media content itself, not by any particular device or application.

In this manner, it can be appreciated that regardless of external factors such as device hardware, user technical ability, network connectivity, or other potential issues, the invention may provide for enhanced media consumption to any user that may wish to partake in the functions provided and it should be further appreciated that such functionality is purely optional and users who do not wish to take advantage of any features or functions of the invention may continue to enjoy their media as usual with no interference from the invention. In this manner, the features of the invention may be made available to anyone even if they are unaware of it, and may remain available “in the background” while media consumption continues normally, until the use of the invention is desired. It should be appreciated that such an approach may appeal to the widest potential audience, offering enhanced functionality at no cost to the user.

It should be appreciated that the hardware and software arrangements described are exemplary, and additional or alternate arrangements may be utilized according to the invention. Furthermore, it should be appreciated that the various uses, functions, and operations described above with respect to each exemplary system architecture may be interchangeable, facilitating the varied functions described with any system arrangement including (but not limited to) each of those described above. It should be further appreciated that metadata as described according to the embodiments of the invention may vary in nature, and may be text-based, audio, or visual in nature and that text-based metadata is described only by way of example. It should therefore be appreciated that any arbitrary information, regardless of the nature of the information or the encoding thereof, may be associated with media content for presentation to and interaction by a user.

Several exemplary use cases for the functions described herein in the preferred embodiment and alternate arrangements are described below, and it should be appreciated that while specific uses, arrangement, or technologies may be described, these are provided as exemplary and a variety of alternate or additional uses, arrangement, or technologies may be utilized according to the invention.

In an exemplary arrangement, a user may be listening to a radio broadcast via an in-car media player (as is common in the art). According to the embodiments described above (referring to FIGS. 4-6), the media player may request or receive metadata associated with currently-playing content such as songs or advertisements, and may queue or buffer this metadata to effectively provide a “short-term memory” of recent media and associated information. In such an arrangement, a user may be listening to streaming audio (such as from a terrestrial or satellite radio broadcast, or an Internet-based media streaming service such as PANDORA™ or SPOTIFY™, for example). In the art it is common to occasionally play audio advertisements or promotions between media segments, such as after a song has finished playing and before the next one begins. In such an arrangement, the user may hear an advertisement for a product or service they are interested in, and may hear contact information such as a phone number or email address for further information. Traditionally, the user would have to remember the information, or write it down or otherwise notate it for future reference—both tasks that may be difficult while driving to a destination. According to the invention, the user may instead simply speak a simple command such as “call” (for a phone number in an advertisement) or “message” (for an email address or text message number), and according to their particular arrangement (such as using a smartphone paired to the media player via BLUETOOTH™ or similar communication means, or via direct interaction with devices integral to or operated by the vehicle or media player) the call or message may be initiated in response to the command.

For example, if the user is using their smartphone paired to the vehicle's media player (such as to stream music stored on their smartphone), the media player may receive their voice command and retrieve the needed information (such as a phone number from the advertisement) from buffered metadata. The media player may then provide the information to the smartphone along with a command to initiate a phone call (optionally with a confirmation prompt, such as “call 555-1234, correct?”, to allow the user to correct the number or change their mind). It should be noted that according to this example, the source of the media may vary while still utilizing the smartphone to place an outbound call. For example, a user may be listening to a radio broadcast and hear a promotion for a concert that they are interested in, offering tickets to callers who dial a specific number (as is common in the art, for example “be the nth caller to win two tickets”). As above, they may speak a simple command to initiate a call to the number in the promotion, which may be provided to their phone as needed by the media device.

In another exemplary use, a user may be playing a game or browsing content on a home gaming console such as an XBOX™ or PLAYSTATION™ or other network-capable gaming device. They may see a promotion for discounted game content, such as offering a temporary discount to players who subscribe to a mailing list (as is common in the art). Ordinarily, the user would be required to note the e-mail address and then go to an e-mail capable device (such as a personal computer or a smartphone) and send an email to the address manually. According to the invention, they may instead speak a simple command such as “subscribe” or “message”, which may then be used to determine the nature of the command (in this case, sending an e-mail message to an address on the screen). The address needed may then be retrieved from known metadata (such as recently-viewed content, which would ideally include at least the text content that has been recently displayed on the screen, such that anything the user may have seen or read may be known), which may then be provided to an e-mail capable device for use in sending a pre-constructed message or optionally prompting the user for further interaction such as to dictate the content of the message.

In another exemplary use, a user may be watching media on a television set with network capabilities (a “smart TV” as known in the art). They may see a television commercial for a product or service they are interested in, and as with a radio example described previously, may be given a phone number to call for additional information or to make a purchase. They may speak a command such as “call”, and the number that was shown may be known from recent metadata and retrieved. The number may then be provided to the user's phone, such as a smartphone known to the smart TV (such as a device that has been previously paired for the purpose of sharing media content), or a phone associated with their television account (such as a landline phone stored as a contact number in their TV service account with a service provider), and a call may be initiated.

A further potential use case may involve the use of a location information device, such as a GPS receiver or integral GPS capability of a user's device (such as a smartphone or tablet computing device). A user may be en route to a destination, such as to meet a friend, and may call or otherwise contact the friend to confirm the route. As the other party provides directions or landmarks, they may be received as voice commands according to the invention, and recent metadata (in this case, routing information from the user's device or current or recent location information from a GPS device) may be used to display or replay (such as via audio text-to-speech or similar functionality, as may be desirable while a user is driving and should not be visually distracted) new directions or routing information based on the received information from the other party over the call. In this manner, it should be appreciated that additional hardware functions may be incorporated according to the invention to enable new forms of metadata and ways to utilize it according to the methods of the invention, such as utilizing location information as metadata to process commands related to mapping or routing functions. It should be further appreciated that additional or alternate functions and hardware may be utilized according to the invention, such as (for example) as new hardware is added to smartphones or other mobile devices that may be commonly used or functionally desirable for use according to the invention.

In this manner it may be appreciated that various arrangements of devices, commands, metadata types, and communication methods may be utilized according to the invention, and it should be further appreciated that the examples given may function as described while utilizing a variety of metadata arrangements such as those described previously (referring to FIGS. 4-6), for example distributed or local metadata caching or buffering arrangements. It should be further appreciated that the exemplary uses and arrangements may vary widely and additional or alternate uses may be possible according to the invention.

### DETAILED DESCRIPTION OF EXEMPLARY EMBODIMENTS

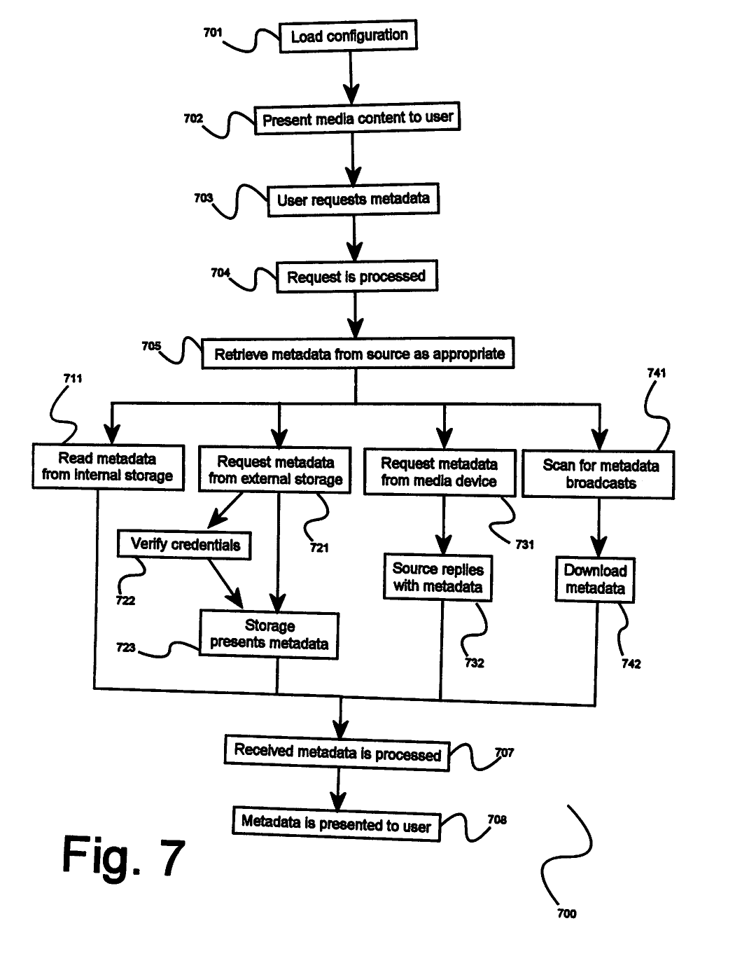

FIG. 7 is a method diagram illustrating an exemplary method 700 for association and interaction with media metadata according to a variety of potential systems for such functionality (such as those described above, referring to FIGS. 4-6), according to an embodiment of the invention.

In an initial step 701, configuration information may be loaded for operation. Such information may be preset (such as a specific configuration from a service provider or software product vendor, that might be provided alongside an application for media interaction according to the invention) or user-defined such as by making a plurality of selections upon starting a software app, or may be loaded from a stored configuration profile (which itself may also be user-defined or preset). Configuration information may be loaded by a software application for media interaction (such as a mobile app on a smartphone or other mobile electronic device), or loaded into a user's web browser via “cookies” or similar session-specific or persistent information, or may be loaded by a physical device for media interaction such as a dedicated hardware component to be used in conjunction with other devices (such as a mobile phone accessory for non-smartphone devices to enable additional functionality via plugging into the phone or a wireless connection such as via Bluetooth™) or a dedicated device such as a terminal or kiosk-style computing system dedicated for media interaction, such as might be utilized in a physical vendor of media data (for example, a music retailer might have a dedicated kiosk that will interact with metadata associated with whatever songs are being played over the store's speaker system).

In a second step 702, media content (such as audio or video content) may be presented to a user. Such presentation may be from a stored source such as a user watching a video on DVD or other data storage device, or may be streaming from a remote or third-party source, such as a radio broadcast or internet-based streaming media. In a next step 703, a user may request additional information based on such media. Such a request might vary in nature according to the invention, such as clicking or otherwise interacting with an interface element on a computer or other electronic device, or verbally requesting information either generally or specifically, according to the user's preference or the capabilities of a device upon which the user is receiving media content.

In a next step 704, a software element may receive a user's request and process it. Such a software element may be a dedicated application operating on the user's device (such as a mobile app on a smartphone or tablet computing device), or may be a remotely-operated software service such as may be appropriate for a user requesting information associated with a streaming internet-based media source. Processing may involve simply turning an audio request into text or other useful format for device operation, or may involve additional functions such as identifying what specific media content is being viewed or is relevant to a request, as well as determining the nature of metadata such as where to find the source for metadata retrieval or how to present such metadata to a user. For example, text-based metadata could be presented on a device's screen for user viewing, or could be sent to a user's mobile phone as a text message for storage or later reference. Audio-based media could be played over a device's speakers while the associated media is paused or muted, or video-based metadata may be played on an appropriately-capable device or application. In this manner, metadata of any format may be retrieved and presented appropriately, avoiding any issues with unrecognized formats or incompatible media types. Such behavior might be user-configurable, such as by selecting options in a media interaction application or saving a preference in a stored configuration profile, either of which may have been loaded in an initial step 701 as described above. For example, a user might configure a smartphone (or similar mobile electronic device) to display text-based metadata on-screen when on a wi-fi connection (as is common when a phone user is at home or work), but to send such data as a text message when on a cellular connection (such as when driving).

In a next step 705, metadata may be retrieved from any appropriate source that may be varied in nature, as determined by processing performed in a previous step and as illustrated by alternate method branches described below. A metadata source may be selected in particular, or all available sources may be attempted until one succeeds and metadata is found, and again such behavior may be configurable as in an initial step 701 described above, or may inherent to the operation of a device or application providing a user with media interaction capabilities according to the invention.

In an initial branch step 711, metadata may be retrieved from a device's internal storage such as a hard drive or other non-removable physical storage, removable storage medium such as a USB storage device or memory card, or software-based storage such as a database (which may be of varied format and structure according to the invention).

In an alternate branch step 721, metadata may be requested from an external repository such as a cloud-hosted database or similar third-party storage service, which may be accessible via the Internet or similar communication network. Such services may require authentication prior to access (as is common in cloud-based storage services to provide their customers with a measure of information security), and in an optional step 722 any needed credentials may be presented for verification. Such credentials may be determined from known configuration in an initial step, described previously. In a next branch step 723, remote storage may present metadata to the requesting device or application as requested.

In an alternate branch step 731, metadata may be requested from a media source device directly, such as a television or music player. Such interaction may be accomplished via any of a number of means or protocols, such as including (but not limited to) Bluetooth™, wi-fi, cellular radio communications, or any other appropriate communication means that may be suitable for both devices. Such communication may be determined by configuration data as determined in an initial step 701 described above, or may configured as needed such as by presenting a user with a selection of available communication methods to choose from, or may be automatically determined by a device or application to establish a connection automatically for maximum user convenience. In a next branch step 732, a media source device may reply to a request with desired metadata, transmitting such metadata to the requesting device over an established communication means as determined in a previous step.

In an alternate branch step 741, a device may search available communication networks for any metadata that may be broadcast by a media source, such as a music player that might be playing a song for a user's listening while simultaneously broadcasting metadata associated with the song over an electronic communications network for receipt by any capable device within range. In a next step 742, a device may receive and download metadata if it is found, and processing may continue.

In a next step 706, metadata retrieved from an appropriate source according to alternate branched steps described above may then be processed according to any known configuration such as (for example) opening a particular video application to play video metadata, or sending a message with text-based metadata to a specified mobile number. In a final step 707, the metadata may be presented to a user according to a particular means determined in a previous processing step, and the interaction is now complete and a user may resume media viewing or other activity.

The skilled person will be aware of a range of possible modifications of the various embodiments described above. Accordingly, the present invention is defined by the claims and their equivalents.

What is claimed is:

1. A media interaction system for audio stream metadata integration and interaction, the system comprising:
a communications device comprising program code stored in a memory and adapted to facilitate user communication with similar devices via a data communication network;
a software interface comprising program code stored in a memory and adapted to receive live or delayed audio from a plurality of user devices; and
a data storage subsystem coupled to the communications device and adapted to buffer at least a configurable amount of live audio received from a user device via the interface;
wherein upon receipt of a spoken request from a user, the buffer is screened for metadata comprising contact information and, where contact information is located, an interaction between the user and another party is initiated using the communications device and the contact information.

2. The system of claim 1, further comprising a server computing device comprising program code stored in a memory and adapted to store and provide at least a portion of media-related information to other components of a media interaction system.

3. The system of claim 2, further wherein the server stores at least a portion of media content with the media-related information.

4. The system of claim 2, further wherein the software interface is operated by the server.

5. The system of claim 1, further comprising a GPS device comprising program code stored in a memory and adapted to locate the device on the globe.

6. The system of claim 5, wherein the GPS provides location-based metadata for use by other components of a media interaction system.

7. A method for audio stream metadata integration and interaction, the method comprising the steps of:
buffering, using a data storage subsystem, at least a configurable amount of live audio received from a user device via an interface for receiving live or delayed audio from a plurality of user devices;
screening the buffer for metadata comprising contact information on receipt of a spoken request from a user; and
initiating an interaction between the user and another party using a communications device and based at least in part on contact information found in the buffer.
